(19) United States
(12) Patent Application Publication
(10) Pub. No.: US 2020/0248771 A1
(43) Pub. Date: Aug. 6, 2020

(54) FLUID-CONTROLLED SPRING/DAMPER SYSTEM

(71) Applicant: DRiV Automotive Inc., Lake Forest, IL (US)

(72) Inventor: Rod HADI, Grass Lake, MI (US)

(73) Assignee: DRiV Automotive Inc., Lake Forest, IL (US)

(21) Appl. No.: 16/781,158

(22) Filed: Feb. 4, 2020

Related U.S. Application Data
(60) Provisional application No. 62/800,818, filed on Feb. 4, 2019.

(51) Int. Cl. F16F 9/10; B60G 11/27; B60K 5/12; B62D 24/04; F16F 1/36; F16F 9/43; F16M 13/02; F16F 15/023; F16F 15/08; B60G 17/052; B60N 2/50; B60N 2/52; B60N 2/54

(52) U.S. Cl. CPC F16F 9/10; B60G 2800/162; B60K 5/1208; B62D 24/04; F16F 1/36; F16F 9/43; B60K 5/1283; F16M 13/02; F16F 15/0232; F16F 15/08; B60G 17/0523; B60N 2/501; B60N 2/525; B60N 2/542; B60G 2202/152; F16F 2222/126; B60G 2206/42; F16F 2224/025; B60G 2500/201; F16F 2228/066; B60G 2204/43; B60G 2204/41; B60G 2204/41062; B60G 2202/14; B60G 11/27

(57) ABSTRACT

A vehicle is provided with a vehicle frame or sub-frame structure and at least one of a body structure and engine structure or a plurality of suspension components mounted to the vehicle frame or sub-frame structure and a plurality of fluid-controlled spring/dampers supporting the least one of a body structure and engine structure or a plurality of suspension components to the vehicle frame of sub-frame structure, the plurality of fluid-controlled spring/dampers being connected to a single central pump.

### CROSS-REFERENCE TO RELATED APPLICATIONS

This application claims priority to and the benefit of U.S. provisional application No. 62/800,818, filed on Feb. 4, 2019. The disclosure of the above application is incorporated herein by reference.

### FIELD

The present disclosure relates to spring/damper systems for a vehicle, and more specifically to systems and methods for controlling such spring/damper systems.

### BACKGROUND

The statements in this section merely provide background information related to the present disclosure and may not constitute prior art.

Body mounts connect the frame or subframe of a vehicle to its body. Body mount bushings are rubber or polyurethane pieces that act as a buffer between the body and the frame. These bushings generally dampen vibrations to provide a vehicle occupant a smoother ride.

There are two main types of automotive body design: body-on-frame; and unibody. Body-on-frame construction was used on older passenger cars and is still used today on trucks and sport utility vehicles (SUVs). In body-on-frame designs, there is a ladder frame that holds the suspension and drivetrain parts. The vehicle body or the cab and bed of a truck are set on top of the frame. The body is attached to the frame by the body mounts.

Unibody construction is used on most passenger cars produced today. In unibody designs, the body is made of stamped steel and contains cross members that provide support. The body and frame are integrated into one part or component, hence the term “unibody.” The engine, steering, and suspension parts, though, are held by a subframe. The subframe is connected to the unibody by the body mounts.

In either case, the body mounts hold the body and the frame or subframe together. The bushings provide vibration dampening and also keep metal components from rubbing against each other.

An engine mount is a component that secures the engine in a car to the frame or subframe. In most cars, an engine and transmission are bolted together and held in place by three or four mounts. The mount that holds the transmission is called the transmission mount, others are referred to as engine mounts. One part of the engine mount or transmission mount is bolted to the car body or frame while another part is bolted to the engine or transmission.

Providing mounts and bushings that can accommodate a variety of physical mounting configurations while providing the requisite amount of vibration dampening can be challenging. Further, the mounts and bushings should be low cost and lightweight, while also providing ease of maintenance. Balancing these requirements has been an issue in the design of vehicle mounts and bushings.

These issues related to mounts and bushings, among other issues related to noise, vibration, and harshness (NVH) and weight in motor vehicles, are addressed by the current disclosure.

### SUMMARY

This section provides a general summary of the disclosure and is not a comprehensive disclosure of its full scope or all of its features.

According to a form, a suspension system for a vehicle includes a plurality of fluid-controlled bushings supporting at least two of a body structure to a frame, an engine structure to the frame, a seat structure to the frame, and a plurality of suspension components to the frame. A fluid source having a single pump directly connects with the fluid-controlled bushings.

In a variation, the suspension system further includes a plurality of pressure regulators. Each pressure regulator is operatively connected to one of the plurality of fluid-controlled bushings for controlling a pressure of the fluid delivered to each of the respective fluid-controlled bushings by the single pump. In another such variation, a controller controls each of the pressure regulators. In a further such variation, the controller is configured to receive input from at least one of a user, external sensors, and components of the vehicle. In a further still such variation, the external sensors comprise at least one of pressure sensors and height sensors. In yet another such variation, each of the fluid-controlled bushings are independently controllable.

In another variation, the fluid source is a pump that provides compressed air to each of the plurality of fluid-controlled bushings.

In yet another variation, the plurality of fluid-controlled bushings comprise an elastic material. In yet another such variation, the elastic material is a reinforced rubber.

In a further variation, the plurality of fluid-controlled bushings define different geometries.

In a still further variation, the suspension system includes a plurality of brackets disposed between each of the fluid-controlled bushings and the frame.

In a yet further variation, a plurality of brackets are disposed between each of the fluid-controlled bushings and the at least two of the body structure, the engine structure, the seat structure, and the plurality of suspension components.

In another form, a suspension system for a vehicle includes a plurality of fluid-controlled bushings supporting at least two of a body structure to a frame, an engine structure to the frame, a seat structure to the frame, and a plurality of suspension components to the frame. A fluid source having a single pump is directly connected to the plurality of fluid-controlled bushings. A plurality of pressure regulators are each operatively connected to one of the plurality of fluid-controlled bushings for controlling a pressure of fluid delivered to each of the respective fluid-controlled bushings by the single pump, and a controller controls each of the pressure regulators.

In a variation, the controller is configured to receive input from at least one of a user, external sensors, and components of the vehicle. In another such variation, the external sensors include at least one of pressure sensors and height sensors.

In another variation, each of the fluid-controlled bushings are independently controllable.

In another form, a method of controlling a suspension system for a vehicle includes providing pressurized fluid to a plurality of fluid-controlled bushings that support at least two of a body structure to a frame, an engine structure to the frame, a seat structure to the frame, and a plurality of suspension components to the frame from a fluid system having a single pump.

In a variation, a plurality of pressure regulators are each operatively connected too one of the plurality of fluid-controlled bushings for controlling a pressure of fluid delivered to each of the respective fluid-controlled bushings by the single pump, and a controller controls each of the pressure regulators. In another such variation, the controller receives input from at least one of a user, external sensors, and components of the vehicle. In yet another such variation, each of the fluid-controlled bushings are independently controllable.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a plurality of fluid-controlled spring/dampers according to the teachings of the present disclosure;

FIG. 2 is a schematic cross-sectional view of a fluid-controlled spring/damper mounted between a vehicle frame or sub-frame and a vehicle body according to the teachings of the present disclosure;

FIG. 3 is a schematic cross-sectional view of another fluid-controlled spring/damper mounted between a vehicle frame or sub-frame and an engine according to the teachings of the present disclosure; and

FIG. 4 is a schematic cross-sectional view of yet another fluid-controlled spring/damper mounted between a vehicle frame or sub-frame and a suspension component according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

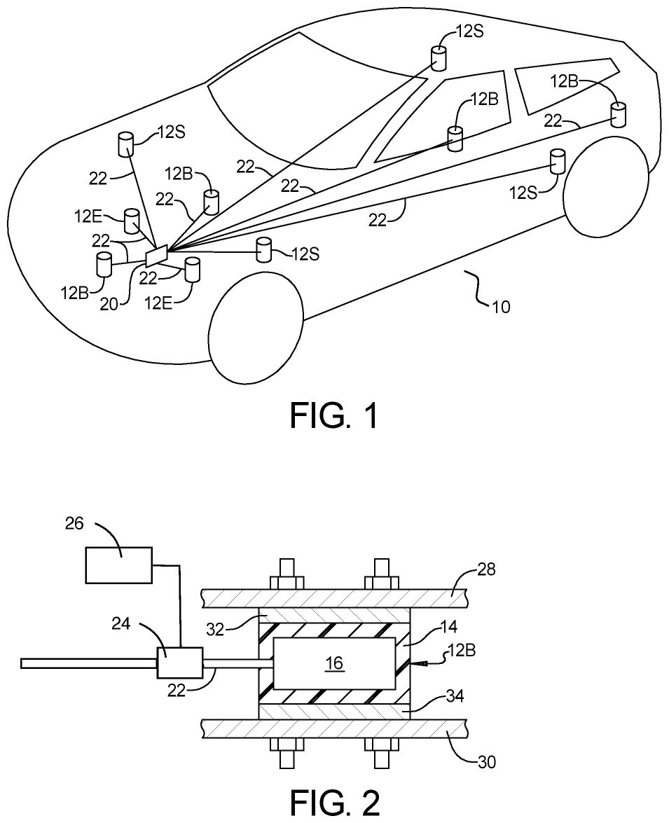

With reference to FIGS. 1 through 4, a suspension system for a vehicle 10 is schematically shown including a plurality of fluid-controlled spring/dampers 12B, 12E, 12S, which are also referred to herein as fluid-controlled bushings. The fluid-controlled spring/dampers 12B, 12E, 12S each include an outer wall 14 defining an internal cavity 16 and are all directly connected to a fluid source, which in one form is a single pump 20, (such as a pump that supplies compressed fluid) by fluid conduits 22, which in one form are hoses. It should be understood that the term “fluid” as used herein should be construed to mean a medium that is solid, liquid, gas, or plasma. Although the gas of compressed air is employed in one form, it should be understood that any fluid may be employed while remaining within the scope of the present disclosure. Additionally, the term “bushing” as used herein should be construed to mean a device that provides stiffness and dampening for improved NVH characteristics. Accordingly, the fluid-controlled bushings as disclosed herein may take on a variety of forms and include a variety of materials and components while remaining within the scope of the present disclosure.

In one form, a plurality of pressure regulators 24 are operatively connected to each of the plurality of fluid-controlled bushings 12B, 12E, 12S, so that the pressure or flow of fluid delivered to each of the respective fluid-controlled bushings 12B, 12E, 12S can be controlled. Each pressure regulator 24 can be independently controlled, e.g., by a controller 26. The controller 26 can be configured to receive input from multiple sources, such as a user, external sensors, components of the vehicle, and the like. As such, the controller 26 can be part of an autonomous vehicle control system, or the controller 26 can be responsive to input from a driver or operator. In this manner, the controller 26 can directly or indirectly change the characteristics of any of the plurality of fluid-controlled bushings 12B, 12E, 12S. External sensors include pressure sensors, height sensors, and the like. Further, each pressure regulator 24 can be independently controlled by the controller 26.

Referring to FIG. 2, the fluid-controlled spring/dampers 12B in one form are utilized as body mounts for mounting the vehicle body structure 28 to the vehicle frame or sub-frame 30. As shown, the fluid-controlled spring/damper 12B is mounted between the vehicle frame or sub-frame 30 and the vehicle body structure 28. Accordingly, the fluid-controlled spring/damper 12B absorbs vibrations between the vehicle frame or sub-frame 30 and the vehicle body structure 28. The upper end of the fluid-controlled spring/damper 12B includes an optional upper bracket 32 mounted to the vehicle body structure 28 and the lower end of the fluid-controlled spring/damper 12B includes an optional lower bracket 34 mounted to the frame or sub-frame 30. While a single upper bracket 32 and a single lower bracket 34 is illustrated, it is contemplated there could be additional of either or both of upper bracket 32 and lower bracket 34. Further, the brackets 32/34 may take on any of a variety of geometric configurations other than those illustrated herein, provided the function of mounting the fluid-controlled spring/damper 12B to the adjacent vehicle body structure 28 and frame/sub-frame 30 is maintained.

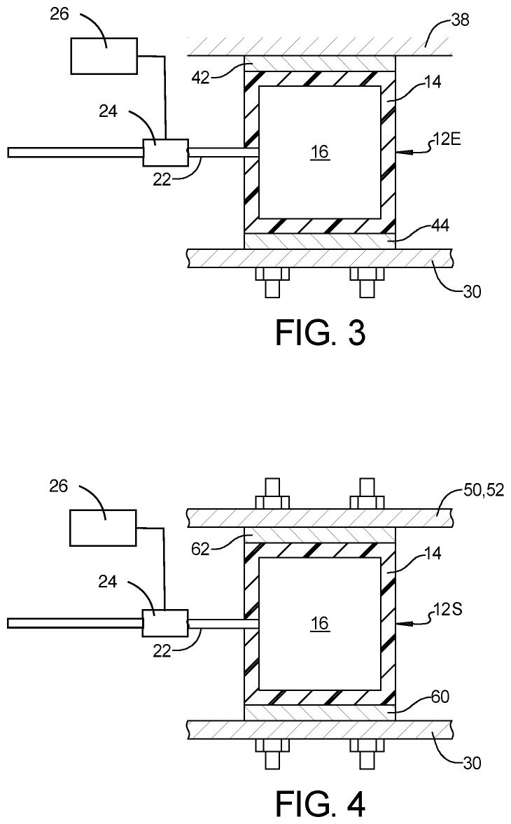

Referring to FIG. 3, the fluid-controlled spring/dampers 12E in another form are utilized as engine mounts for mounting the engine 38 to the vehicle frame or sub-frame 30. As shown, the fluid-controlled spring/damper 12E is mounted between the vehicle frame or sub-frame 30 and the engine 38. Accordingly, the fluid-controlled spring/damper 12E absorbs vibrations between the vehicle frame or sub-frame 30 and the engine 38. The upper end of the fluid-controlled spring/damper 12E includes an upper bracket 42 mounted to the engine 38 and the lower end of the fluid-controlled spring/damper 12E includes a lower bracket 44 mounted to the frame or sub-frame 30. While a single upper bracket 42 and a single lower bracket 44 is illustrated, it is contemplated there could be additional of either or both of upper bracket 42 and lower bracket 44. Further, the brackets 42/44 may take on any of a variety of geometric configurations other than those illustrated herein, provided the function of mounting the fluid-controlled spring/damper 12E to the adjacent engine structure 38 and frame/sub-frame 30 is maintained.

As shown in FIG. 4, the fluid-controlled spring/dampers 12S of the present disclosure can include a lower bracket 60 connected to the vehicle frame or sub-frame 30 and can include an upper bracket 62 connected to a suspension component 50 or vehicle seat 52 to dampen vibrations between the vehicle frame or sub-frame 30 and suspension components 50 or vehicle seats 52. While a single upper bracket 62 and a single lower bracket 64 is illustrated, it is contemplated there could be additional of either or both of upper bracket 62 and lower bracket 64. Further, the brackets 60/62 may take on any of a variety of geometric configurations other than those illustrated herein, provided the function of mounting the fluid-controlled spring/damper 12S to the adjacent suspension component 50/vehicle seat 52 and frame/sub-frame 30 is maintained.

The fluid-controlled spring/dampers 12B, 12E, 12S are all connected to the fluid source that is a single pump 20 so that the fluid-controlled spring/dampers 12B, 12E, 12S provide damping to provide improved NVH characteristics. It is contemplated that in this manner, the spring/dampers 12B, 12E, 12S can support at least two of the body structure 28 to the frame 30, the engine structure 38 to the frame 30, the seat structure 52 to the frame 30, and the plurality of suspension components 50 to the frame 30 and can be controlled by the fluid source that is a single pump 20. The fluid-controlled spring/dampers 12B, 12E, 12S are lighter than solid rubber body, engine, and suspension mounts and therefore provide vehicle weight reduction. The size and shape of the fluid-controlled spring/dampers can be selected to provide adequate support between components when the fluid-controlled spring/damper 12B, 12E, 12S is not provided with pressure (e.g., compressed air) during a static condition. In other words, some or all of the fluid-controlled bushings can have different geometries from one another; the fluid-controlled spring/dampers 12B could have different geometries from one or both of the fluid-controlled spring/dampers 12E, 12S; some fluid-controlled spring/dampers 12B could have different geometries of other fluid-controlled spring/dampers 12B. Other combinations of geometries not explicitly stated herein are also contemplated. The supply of fluid to the fluid-controlled spring/dampers 12B, 12E, 12S provides a damping function between the components when the vehicle is subjected to dynamic loads. Accordingly, the materials of the fluid-controlled spring/dampers can be reinforced rubber or other elastic material that can provide adequate static support. The pressure (e.g., compressed air) supplied by the fluid source of a single pump 20 can be selected to give a desired ride characteristic. Higher pressures provide stiffer support and lower pressures provide more flexible support.

Appropriate fluids include air, such as compressed air; light-weight, non-flammable liquids; or other gases or liquids that can provide desired damping characteristics.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” and/or “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The module may include one or more interface circuits. In some examples the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A suspension system for a vehicle comprising:
a plurality of fluid-controlled bushings supporting at least two of a body structure to a frame, an engine structure to the frame, a seat structure to the frame, and a plurality of suspension components to the frame; and
a fluid source consisting of a single pump, wherein the plurality of fluid-controlled bushings are directly connected to the fluid source.

2. The suspension system according to claim 1 further comprising a plurality of pressure regulators, wherein each pressure regulator is operatively connected to one of the plurality of fluid-controlled bushings for controlling a pressure of fluid delivered to each of the respective fluid-controlled bushings by the single pump.

3. The suspension system according to claim 2, further comprising a controller for controlling each of the pressure regulators.

4. The suspension system according to claim 3, wherein the controller is configured to receive input from at least one of a user, external sensors, and components of the vehicle.

5. The suspension system according to claim 4, wherein the external sensors comprise at least one of pressure sensors and height sensors.

6. The suspension system according to claim 3, wherein each of the fluid-controlled bushings are independently controllable.

7. The suspension system according to claim 1, wherein the fluid source is a pump that provides compressed air to each of the plurality of fluid-controlled bushings.

8. The suspension system according to claim 1, wherein the plurality of fluid-controlled bushings comprise an elastic material.

9. The suspension system according to claim 8, wherein the elastic material is a reinforced rubber.

10. The suspension system according to claim 1, wherein the plurality of fluid-controlled bushings define different geometries.

11. The suspension system according to claim 1 further comprising a plurality of brackets disposed between each of the fluid-controlled bushings and the frame.

12. The suspension system according to claim 1 further comprising a plurality of brackets disposed between each of the fluid-controlled bushings and the at least two of the body structure, the engine structure, the seat structure, and the plurality of suspension components.

13. A suspension system for a vehicle comprising:
a plurality of fluid-controlled bushings supporting at least two of a body structure to a frame, an engine structure to the frame, a seat structure to the frame, and a plurality of suspension components to the frame;
a fluid source consisting of a single pump, wherein the plurality of fluid-controlled bushings are directly connected to the fluid source;
a plurality of pressure regulators, wherein each pressure regulator is operatively connected to one of the plurality of fluid-controlled bushings for controlling a pressure of fluid delivered to each of the respective fluid-controlled bushings by the single pump; and
a controller for controlling each of the pressure regulators.

14. The suspension system according to claim 13, wherein the controller is configured to receive input from at least one of a user, external sensors, and components of the vehicle.

15. The suspension system according to claim 14, wherein the external sensors comprise at least one of pressure sensors and height sensors.

16. The suspension system according to claim 13, wherein each of the fluid-controlled bushings are independently controllable.

17. A method of controlling a suspension system for a vehicle comprising providing pressurized fluid to a plurality of fluid-controlled bushings supporting at least two of a body structure to a frame, an engine structure to the frame, a seat structure to the frame, and a plurality of suspension components to the frame from a fluid system consisting of a single pump.

18. The method according to claim 17 further comprising a plurality of pressure regulators, wherein each pressure regulator is operatively connected to one of the plurality of fluid-controlled bushings for controlling a pressure of fluid delivered to each of the respective fluid-controlled bushings by the single pump, and a controller for controlling each of the pressure regulators.

19. The method according to claim 18, wherein the controller receives input from at least one of a user, external sensors, and components of the vehicle.

20. The method according to claim 18, wherein each of the fluid-controlled bushings are independently controllable.
